(19) United States
(12) Patent Application Publication
(10) Pub. No.: US 2022/0358352 A1
(43) Pub. Date: Nov. 10, 2022

(54) DATA ANALYSIS SYSTEM, DATA ANALYSIS METHOD, AND PROGRAM

(71) Applicant: Nippon Telegraph and Telephone Corporation, Tokyo (JP)

(72) Inventors: Yoichi Matsuo, Musashino-shi, Tokyo (JP); Takehiro KAWATA, Musashino-shi, Tokyo (JP); Ken Nishimatsu, Musashino-shi, Tokyo (JP); Tatsuaki Kimura, Musashino-shi, Tokyo (JP)

(21) Appl. No.: 17/618,596

(22) PCT Filed: Jun. 22, 2020
(86) PCT No.: PCT/JP2020/024441

§ 371 Date: Dec. 13, 2021

(30) Foreign Application Priority Data
Jun. 25, 2019 (JP) 2019-117776

(51) Int. Cl. G06N 3/063; G06K 9/00

(52) U.S. Cl. CPC G06N 3/063; G06K 9/00523

(57) ABSTRACT

In the disclosure, a first feature amount extraction unit configured to extract, from time-series data of a plurality of types, a first feature amount representing a feature between dimensions of each data of the time-series data at each time, a second feature amount extraction unit configured to extract, from the first feature amount extracted by the first feature amount extraction unit, a second feature amount representing a feature between the types at each time, a third feature amount extraction unit configured to extract, from the second feature amount extracted by the second feature amount extraction unit, a third feature amount representing a feature between each time, and an analysis unit configured to perform predetermined data analysis through a use of the third feature amount extracted by the third feature amount extraction unit.

### TECHNICAL FIELD

The present invention relates to a data analysis system, a data analysis method and a program.

### BACKGROUND ART

In recent years, it has become common to perform data analysis such as prediction, classification, and regression of desired events using time-series data that can be obtained from various systems such as communication networks and sensor groups, for example. There are various types of data in such time-series data, and each type has its own characteristics. Examples of such types of data include numerical data that can have continuous values, discrete values, number of categories and the like, and text data in the form of sentences. In the following, data of a plurality of types are also referred to as “multimodal data”.

In addition, time-series data often have periodicity, and it is important to understand and extract such periodicity and characteristics of the above types of data. Various methods of analyzing time-series data have been proposed in the related art. For example, a method is known in which through learning of a deep neural network (DNN) using given time-series data, future values are predicted using the DNN.

Here, as a method of performing prediction by applying a convolutional neural network (CNN) to time-series data, a quasi-recurrent neural network (QRNN) is known (see, for example NPTL 1). In the QRNN, for time t+1, prediction is performed using the entirety of data from 1 to t. Specifically, when time-series data {x1, . . . , xt} is given, xt+1 is predicted using xt+1=QRNN (x1, . . . xt). In the QRNN, the filter of the CNN learns the relationship between the time series, the cycle component and the like through learning, and thus the feature in the time-series direction of the data can be extracted.

In addition, as a prediction method for time-series data of sound, Wavenet is known (see, for example, NPTL 2). Since time-series data of sound has very long-term influence on the relationship between data, the Wavenet uses a CNN with xm of a time preceding by m (note that m=2, 4, 8, 16, . . . , M) as an input when predicting xt+1 such that the relationship of the long-term data can be extracted. At this time, the Wavenet also extracts the relationship between data at the time m in a hidden layer of the CNN.

In addition, as a method for prediction through extraction of features of time-series data of a plurality of types, a method called Deepsense is known (see, for example NPTL 3). In the Deepsense, for data with different multi-dimensional features such as the angular velocity, speed, the relationship between the dimensions in each data at each time is extracted first by the CNN, then the relationship between each data at each time is extracted by the CNN, and finally the relationship between the time series is extracted by the recurrent neural network (RNN).

### CITATION LIST

### Non Patent Literature

NPTL 1: Bradbury, James, Merity, Stephen, Xiong, Caiming, and Socher, Richard. Quasi-Recurrent Neural Networks. arXiv preprint arXiv:1611.01576, 2016.
NPTL 2: A. van den Oord et al. “WaveNet: A Generative Model for Raw Audio”. In: ArXiv e-prints (2016).
NPTL 3: Shuochao Yao, Shaohan Hu, Yiran Zhao, Aston Zhang, and Tarek Abdelzaher. “Deepsense: A Unified Deep Learning Framework for Timeseries Mobile Sensing Data Processing”. In Proc. 26th International Conference on World Wide Web, pages 351-360. International World Wide Web Conferences Steering Committee, 2017.

### SUMMARY OF THE INVENTION

### Technical Problem

When performing data analysis of multimodal data, extraction of the feature of data of a plurality of types requires tasks such as prediction of the overall features of each data after dividing the data based on the types and extracting the features, for example. As such, the QRNN and the Wavenet are not suitable for data analysis of multimodal data. While the Deepsense, on the other hand, can perform data analysis on multimodal data, it cannot deal with the case where the type of data is text data and the like.

In view of the above-mentioned points, an object of an embodiment of the present invention is to implement data analysis of time-series data of a plurality of types.

### Means for Solving the Problem

To achieve the above-mentioned object, a data analysis system according to an embodiment of the present invention includes a first feature amount extraction unit configured to extract, from time-series data of a plurality of types, a first feature amount representing a feature between dimensions of each data of the time-series data at each time, a second feature amount extraction unit configured to extract, from the first feature amount extracted by the first feature amount extraction unit, a second feature amount representing a feature between the types at each time, a third feature amount extraction unit configured to extract, from the second feature amount extracted by the second feature amount extraction unit, a third feature amount representing a feature between each time, and an analysis unit configured to perform predetermined data analysis through a use of the third feature amount extracted by the third feature amount extraction unit.

### Effects of the Invention

It is possible to implement data analysis of time-series data of a plurality of types.

### BRIEF DESCRIPTION OF DRAWINGS

FIG. 1 is a drawing illustrating an example of an overall configuration (inference state) of a data analysis system according to an embodiment of the present invention.

FIG. 2 is a drawing illustrating an example of an overall configuration (learning state) of the data analysis system according to the embodiment of the present invention.

FIG. 3 is a drawing illustrating an example of a hardware configuration of the data analysis system according to the embodiment of the present invention.

FIG. 4 is a flowchart illustrating an example of a data analysis process according to the embodiment of the present invention.

FIG. 5 is a drawing illustrating an example of multimodal data.

FIG. 6 is a flowchart illustrating an example of a parameter updating process according to the embodiment of the present invention.

### DESCRIPTION OF EMBODIMENTS

An embodiment of the present invention is described below. In the embodiment of the present invention, a data analysis system 10 that can implement data analysis of time-series data of a plurality of types is described.

In the embodiment of the present invention, it is assumed that, as an example, the time-series data to be subjected to the data analysis is data acquired from a communication network, a sensor group and/or the like. Accordingly, it is assumed that the time-series data to be subjected to the data analysis is time-series data of a plurality of types (i.e., time-series data of multimodal data). Note that examples of the data acquired from a communication network, a sensor group and/or the like include time-series data of numerical data such as a sensor value and time-series data of text data such as a system log. In addition, the examples also include time-series data of numerical data representing whether an abnormality has occurred in a predetermined device (i.e., numerical data that can have discrete values (binary values)) and time-series data of numerical data representing a category to which an internet protocol (IP) address belongs.

In addition, as an example, the embodiment of the present invention describes a case where data prediction is performed as data analysis. It should be noted that the embodiment of the present invention is not limited to data prediction, and may also be applied to a case where data analysis such as data classification and regression is performed, for example.

Here, as described above, the QRNN and the Wavenet are not suitable for data analysis of multimodal data. While the Deepsense, on the other hand, can perform data analysis of multimodal data, it cannot deal with the case where the type of data is text data and the like. In addition, the RNN uses xt−k, . . . , xt for prediction of xt+1. At this time, the RNN predicts xt+1 by repeating prediction of xt−k+j+1 from xt−k+j for j=0, . . . , k. This method is also said to cause gradient explosion or gradient disappearance, and even if data up to the time k is used, it is not clear whether the information of that data is used. Therefore, the data analysis using the RNN is not suitable for the case where the time-series data has long-term relationships.

In general, time-series data acquired from systems such as communication networks and sensor groups often have different relationships and cycles in the time-series direction for each type of data. For this reason, in the case where the data to be used for prediction is explicitly determined and modeled, the time-series data acquired from systems such as communication networks and sensor groups may not be suitable for prediction, because it may not fit the model depending on the relationship and cycle of the data.

In view of this, in the data analysis system 10 according to the embodiment of the present invention, data analysis such as prediction, classification, and regression is performed by extracting the long-term relationships and/or cycles in the time-series direction for time-series data of a plurality of types. Note that the data analysis system 10 is set to “learning state” where the parameter and the like of a neural network are updated using learning data, and “inference state” where time-series data is analyzed with a neural network using a learned parameter.

Overall Configuration

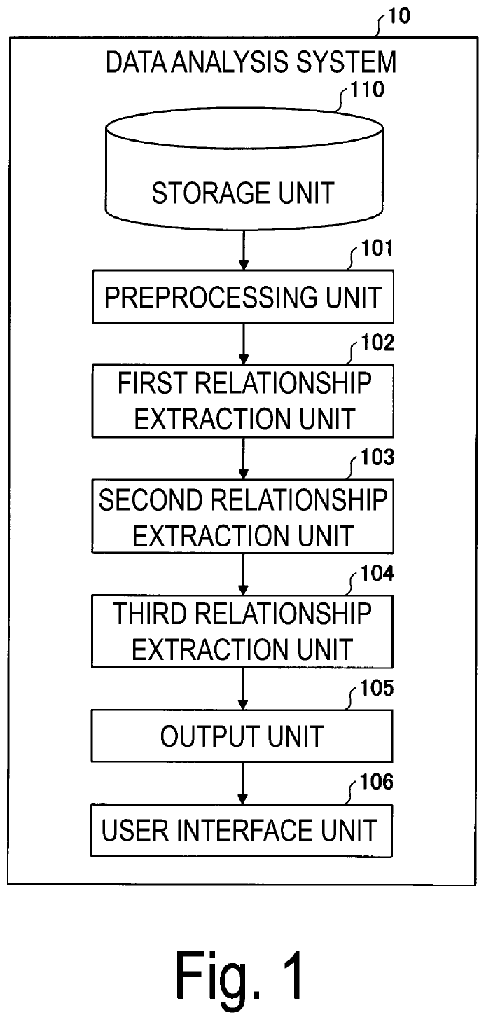

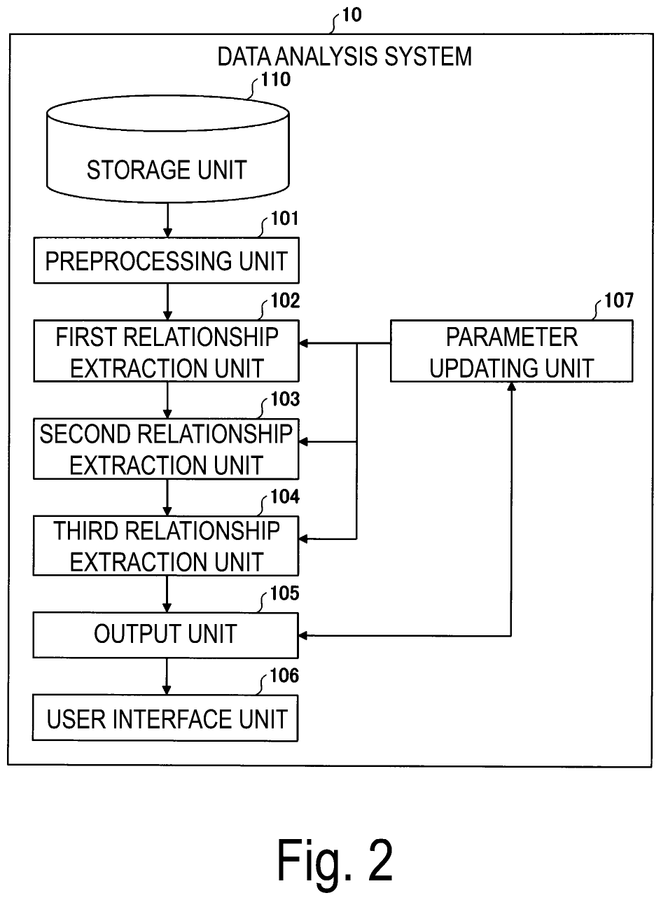

An overall configuration of the data analysis system 10 according to the embodiment of the present invention is described first with reference to FIG. 1 and FIG. 2. FIG. 1 and FIG. 2 are drawings illustrating an example of an overall configuration of the data analysis system 10 according to the embodiment of the present invention.

Inference State

As illustrated in FIG. 1, the data analysis system 10 in the inference state includes a preprocessing unit 101, a first relationship extraction unit 102, a second relationship extraction unit 103, a third relationship extraction unit 104, an output unit 105, a user interface unit 106, and a storage unit 110.

Various types of data are stored in the storage unit 110. In the embodiment of the present invention, it is assumed that time-series data of a plurality of types to be subjected to data analysis are stored in the storage unit 110 in the inference state.

The preprocessing unit 101 reads the time-series data to be subjected to the data analysis from the storage unit 110, and performs a predetermined preprocessing on the time-series data. The preprocessing is, for example, converting text data to vector data numerically, normalizing numerical data, separating the entire time-series data by time windows, or the like.

The first relationship extraction unit 102, which is implemented by a CNN using a learned parameter learned in advance, extracts the relationship (feature) between the dimensions in each data at each time for each type of data with the time-series data having been subjected to the preprocessing as an input.

The second relationship extraction unit 103, which is implemented by a CNN using a learned parameter learned in advance, extracts the relationship (feature) between the types of data at each time with the feature extracted by the first relationship extraction unit 102 as an input.

The third relationship extraction unit 104, which is implemented by a CNN using a learned parameter learned in advance, extracts the relationship (feature) between the time series of the time-series data to be subjected to the data analysis with the feature extracted by the second relationship extraction unit 103 as an input.

The output unit 105 outputs a data analysis result with the feature extracted by the third relationship extraction unit 104 as an input. At this time, the output unit 105 outputs a data analysis result using a predetermined function prepared for each type of data. For example, when prediction and/or regression is performed as data analysis, the output unit 105 outputs a data analysis result using an identity function. On the other hand, for example, when classification is performed as data analysis, the output unit 105 outputs a data analysis result using a softmax function.

The user interface unit 106 provides the data analysis result output by the output unit 105 to a predetermined user interface (UI). Here, the predetermined user interface may be a display device such as a display, or a sound output device such as a speaker. Alternatively, the user interface unit 106 may provide the data analysis result to any user interface.

Learning State

As illustrated in FIG. 2, the data analysis system 10 in the learning state includes the preprocessing unit 101, the first relationship extraction unit 102, the second relationship extraction unit 103, the third relationship extraction unit 104, the output unit 105, the user interface unit 106, a parameter updating unit 107, and the storage unit 110. Note that the preprocessing unit 101, the first relationship extraction unit 102, the second relationship extraction unit 103, the third relationship extraction unit 104, the output unit 105 and the user interface unit 106 are the same as those of the inference state, and therefore the description thereof will be omitted. It should be noted that the first relationship extraction unit 102, the second relationship extraction unit 103 and the third relationship extraction unit 104 are implemented with a CNN using an unlearned parameter.

Various types of data are stored in the storage unit 110. In the embodiment of the present invention, it is assumed that learning data for learning the parameter of the CNN is stored in the storage unit 110 in the learning state. The learning data is data composed of time-series data used for learning of the parameter of the CNN and the correct answer (i.e., teacher data) of the data analysis result of the time-series data. In the learning state, to learn the parameter of the CNN, data analysis is performed using the time-series data included in the learning data thereof.

The parameter updating unit 107 updates the parameter of the CNN that implements each of the first relationship extraction unit 102, the second relationship extraction unit 103 and the third relationship extraction unit 104 by a known optimization method using the data analysis result output by the output unit 105 and the teacher data. In this manner, the parameter of each CNN is learned.

Note that the overall configuration of the data analysis system 10 illustrated in FIG. 1 and FIG. 2 is merely an example, and other configurations may be employed. For example, the data analysis system 10 may be composed of a plurality of devices. In addition, in this case, for example, the functional parts of the data analysis system 10 (the preprocessing unit 101, the first relationship extraction unit 102, the second relationship extraction unit 103, the third relationship extraction unit 104, the output unit 105, the user interface unit 106 and the parameter updating unit 107) may be separately provided in the plurality of devices.

Hardware Configuration

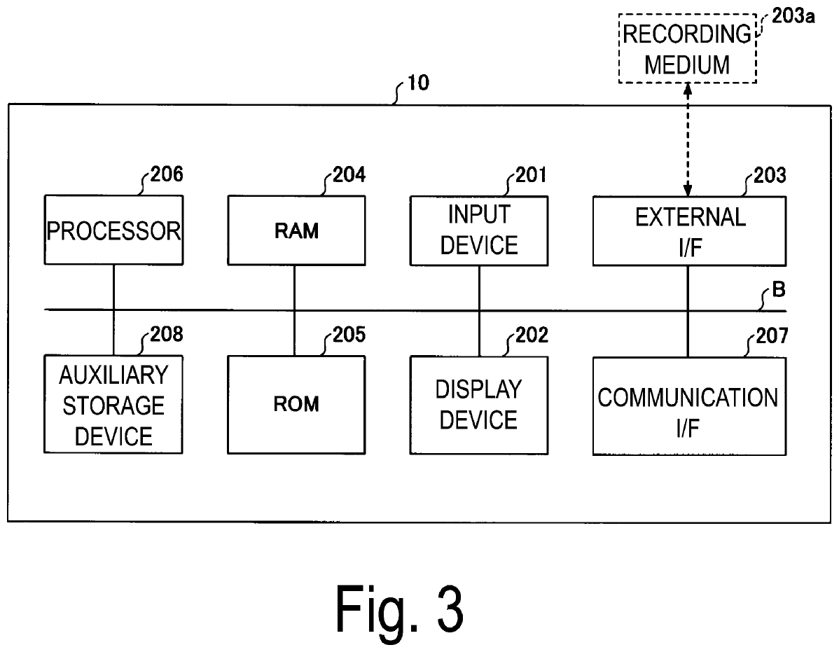

Next, a hardware configuration of the data analysis system 10 according to the embodiment of the present invention is described with reference to FIG. 3. FIG. 3 is a drawing illustrating an example of a hardware configuration of the data analysis system 10 according to the embodiment of the present invention.

As illustrated in FIG. 3, the data analysis system 10 according to the embodiment of the present invention includes an input device 201, a display device 202, an external I/F 203, a random access memory (RAM) 204, a read only memory (ROM) 205, a processor 206, a communication I/F 207, and an auxiliary storage device 208. Each hardware is connected to each other through a bus B in such a manner as to enable mutual communication.

The input device 201 is, for example, a keyboard, a mouse, a touch panel or the like. The display device 202 is, for example a display or the like. Note that the data analysis system 10 may not include at least one of the input device 201 and the display device 202.

The external I/F 203 is an interface for an external device. The external device is a recording medium 203a or the like. Through the external I/F 203, the data analysis system 10 can perform reading and writing in the recording medium 203a and the like. Examples of the recording medium 203a include a compact disc (CD), digital versatile disk (DVD), a secure digital (SD) memory card, and a universal serial bus (USB) memory card. Note that in the recording medium 203a, one or more programs that implement the functional parts of the data analysis system 10 (e.g., the preprocessing unit 101, the first relationship extraction unit 102, the second relationship extraction unit 103, the third relationship extraction unit 104, the output unit 105, the user interface unit 106 and the like) may be recorded.

The RAM 204 is a volatile semiconductor memory that temporarily holds a program and/or data. The ROM 205 is a nonvolatile semiconductor memory that can hold a program and/or data even when the power is turned off.

The processor 206 is, for example, a computation device such as a central processing unit (CPU) and a graphics processing unit (GPU), and executes a process by reading a program and/or data from the ROM 205, the auxiliary storage device 208 and/or the like to the RAM 204. Each functional part of the data analysis system 10 is implemented through a process executed by the processor 206 based on one or more programs stored in the auxiliary storage device 208, for example. Note that the data analysis system 10 may include both the CPU and the GPU, or only one of the CPU and the GPU, as the processor 206. In addition, the data analysis system 10 may include a field-programmable gate array (FPGA) and the like, as the processor 206.

The communication I/F 207 is an interface for connecting the data analysis system 10 to the communication network. The one or more programs that implement the functional parts of the data analysis system 10 may be acquired (downloaded) from a predetermined server device and the like through the communication I/F 207.

The auxiliary storage device 208 is, for example, a hard disk drive (HDD), a solid state drive (SDD) or the like, and is a nonvolatile storage device storing a program and/or data. The program and/or data stored in the auxiliary storage device 208 is, for example, one or more programs that implements each functional part of the data analysis system 10 and an operating system (OS), or the like. The storage unit 110 of the data analysis system 10 may be implemented using the auxiliary storage device 208. It should be noted that the storage unit 110 may be implemented using a storage device connected to the data analysis system 10 through the communication network, or the like.

With the hardware configuration illustrated in FIG. 3, the data analysis system 10 according to the embodiment of the present invention can implement the data analysis process and/or the parameter updating process described later. Note that in the example illustrated in FIG. 3, the data analysis system 10 according to the embodiment of the present invention is implemented with one device (computer), but the present invention is not limited to this. The data analysis system 10 according to the embodiment of the present invention may be implemented with a plurality of devices (computers). In addition, the one device (computer) may include a plurality of the processors 206 and/or a plurality of memories (the RAM 204, the ROM 205, the auxiliary storage device 208 and the like).

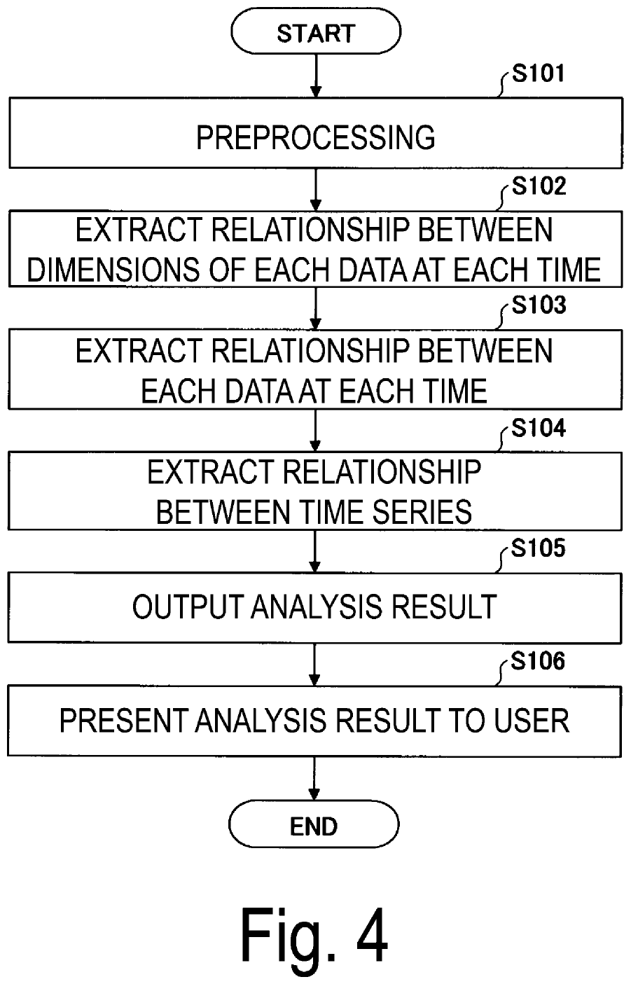

Data Analysis Process A data analysis process in the inference state is described below with reference to FIG. 4. FIG. 4 is a flowchart illustrating an example of a data analysis process according to the embodiment of the present invention. Note that it is assumed that in the data analysis process, the parameter of the CNN that implements each of the first relationship extraction unit 102, the second relationship extraction unit 103 and the third relationship extraction unit 104 has been learned in advance.

First, the preprocessing unit 101 reads time-series data to be subjected to the data analysis from the storage unit 110, and performs a predetermined preprocessing on the time-series data (step S101). As described above, the preprocessing is, for example, converting text data to vector data numerically, normalizing numerical data, separating the entire time-series data by time windows, or the like.

In the following, it is assumed that the time-series data to be subjected to the data analysis is sectioned into t time windows, and each time window is associated with one time index for each type of data. More specifically, it is assumed that data of a type k at a time t is represented by xkt where k (k=1, . . . , K; note that K≥2) represents the type of data and t (t is an integer of 1 or more) represents the time index. In addition, it is assumed that the number of the dimensions of data of the type k is represented by Nk (note that Nk≥1).

Here, when converting text data into numerical values, the preprocessing unit 101 performs conversion to vector data using templates that are numbered in advance. More specifically, with the total number of the templates as Nk, the preprocessing unit 101 specifies templates that match or resemble to fixed character strings other than variable portions (e.g., character strings representing observation values and the like) of the text data, and then converts the text data into Nk-dimensional vector data in which only the element corresponding to the number given to the specified template is 1 and other elements are 0.

In addition, for numerical data representing a category to which an IP address belongs, the preprocessing unit 101 converts the numerical data into vector data. More specifically, with the total number of the categories as Nk, the preprocessing unit 101 converts the numerical data into an Nk-dimensional vector in which only the element corresponding to the category to which the IP address belongs is 1 and other elements are 0.

In addition, for address data representing an IP address, the preprocessing unit 101 converts the address data into vector data. More specifically, with the total number of IP address spaces as Nk, the preprocessing unit 101 converts the address data into an Nk-dimensional vector in which only the element corresponding to the IP address space to which the IP address represented by the address data belongs is 1 and other elements are 0.

Note that, in the following, the preprocessing unit 101 also represents data whose number of the dimensions is 1 (i.e., numerical data represented as a scalar) as vector data. In this manner, various types of data such as numerical data, text data, and address data are represented as vector data.

In addition, when the time window corresponding to the time t contains a plurality of vector data, xkt may be representative vector data of the plurality of vector data in the time window or vector data obtained through compilation (such as summing, averaging, and median value calculation) of the plurality of vector data in the time window.

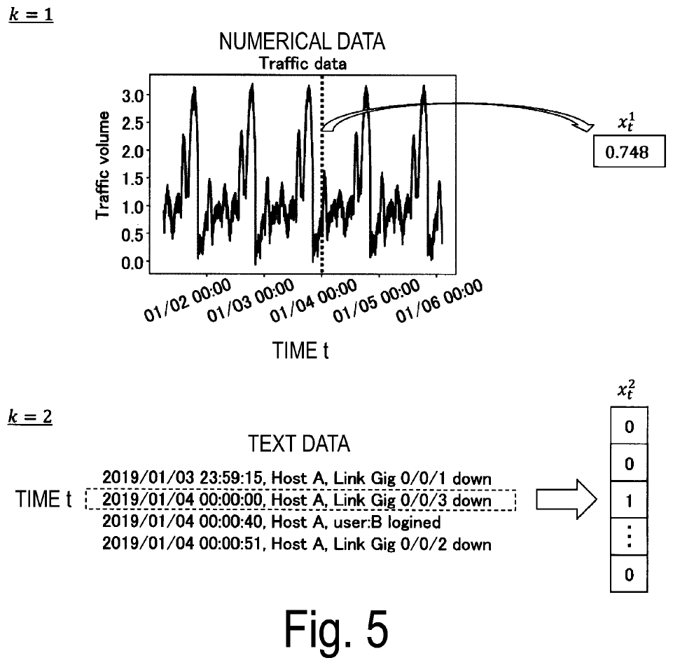

FIG. 5 illustrates an example of multimodal data in the case where K=2, the type of data of k=1 is numerical data, and the type of data of k=2 is text data. In the example illustrated in FIG. 5, the numerical data at the time t is represented by one dimension vector data x1t. In addition, the text data at the time t is converted into N2-dimensional vector data x2t, and is represented by the vector data x2t.

Note that FIG. 5 illustrates an example case where the time window corresponding to the time t contains only one data. For example, in the case where the time window corresponding to the time t contains two text data (first text data and second text data), x2t may be a vector data represented by a sum of a first vector in which only the element corresponding to the first text data is 1 and other elements are 0 and a second vector in which only the element corresponding to the second text data is 1 and other elements are 0, for example.

In addition, as for normalization, the preprocessing unit 101 may divide the entirety of the time-series data to be subjected to the data analysis by the maximum value of the time-series data included in the learning data for each type k, for example. More specifically, the preprocessing unit 101 may normalize each vector data xkt for each k and each t in the following manner.

$${\hat{x}}_{t}^{k} = \frac{{x}_{t}^{k}}{{max}_{t} \{ {x}_{t}^{k} \}} \qquad [ Equation 1 ]$$

In the following, normalized vector data is also represented by xkt.

Next, the first relationship extraction unit 102 extracts the relationship (feature) between dimensions in each vector data xkt at each time t through the use of the vector data xkt on which the preprocessing has been performed at the step S101 (step S102). More specifically, the first relationship extraction unit 102 inputs xkt to a 1dCNN (i.e., a CNN for a vector) using a learned parameter and outputs a vector expressed in the following Equation 2.

zₜ^{(1),k} [Equation 2]

Here, it is assumed that the number of the dimensions of the vector output by the 1dCNN is N1 set in advance. The sliding window and the filter size of the CNN are adjusted for each k such that the number of the dimensions of the vector output by the 1dCNN is N1. In this manner, it is possible to extract the feature amount from the vector data xkt, and set, to the same size, the vector data of different sizes for each k.

Note that at the step S102, for example, a principal component analysis (PCA), or an encoder of an autoencoder may be used in place of the 1dCNN.

Next, the second relationship extraction unit 103 extracts the relationship (feature) between types k of the vector data at each time t (step S103) through the use of the vector data expressed in the following Equation 3 output at the step S102.

zₜ^{(1),k} [Equation 3]

More specifically, the second relationship extraction unit 103 creates a matrix expressed in the following Equation 5 in which the following Equation 4 is arranged in the row direction.

zₜ^{(1),k} [Equation 4]

zₜ⁽¹⁾∈R^{k×N}^{₁} [Equation 5]

Then, the second relationship extraction unit 103 inputs z(1)t to a 2dCNN (i.e., a CNN for a matrix) using a learned parameter, and outputs a matrix expressed in the following Equation 6.

zₜ⁽²⁾∈R^{k}^{₂}^{×N}^{₂} [Equation 6]

Here, k2 and N2 are set in advance. In this manner, it is possible to extract the feature amount between the types k of each data at each time t.

Next, the third relationship extraction unit 104 extracts the relationship (feature) between the time series through the use of the matrix data z(1)t output at the step S103 (step S104). More specifically, the third relationship extraction unit 104 creates a matrix expressed in the following Equation 7 in which the matrix data z(i)t from the time 1 to time t is arranged in the column direction.

z⁽²⁾∈R^{k}^{₂}^{×tN}^{₂} [Equation 7]

Then, the third relationship extraction unit 104 inputs Z(2) to the 2dCNN using a learned parameter and outputs a matrix expressed in the following Equation 8.

z⁽³⁾∈R^{k}^{₃}^{×N}^{₃} [Equation 8]

Here, k3 and N3 are set in advance. In this manner, a feature amount from the time 1 to time t can be extracted.

Subsequently, the output unit 105 performs data analysis using the matrix data Z(3) output at the step S104, and outputs a data analysis result (step S105). Specifically, for example, when prediction is performed as the data analysis, the output unit 105 predicts xkt+1, and outputs this xkt+1. As described above, the output unit 105 outputs the data analysis result through the use of a predetermined function (such as an identity function and a softmax function) prepared for each type k of the data.

Finally, the user interface unit 106 provides the data analysis result output at the step S105 to a predetermined UI (step S106). In this manner, the data analysis result is presented to the user.

As described above, the data analysis system 10 according to the embodiment of the present invention extracts the feature between the dimensions of each data at each time, and then extracts the feature between each data at each time, and finally, extracts the feature between the time series. In this manner, the data analysis system 10 according to the embodiment of the present invention can extract the feature and/or the periodicity in the time-series direction while extracting the feature of data and the feature between data from multimodal time-series data, and thus can achieve data analysis of multimodal time-series data with a high accuracy.

Parameter Updating Process

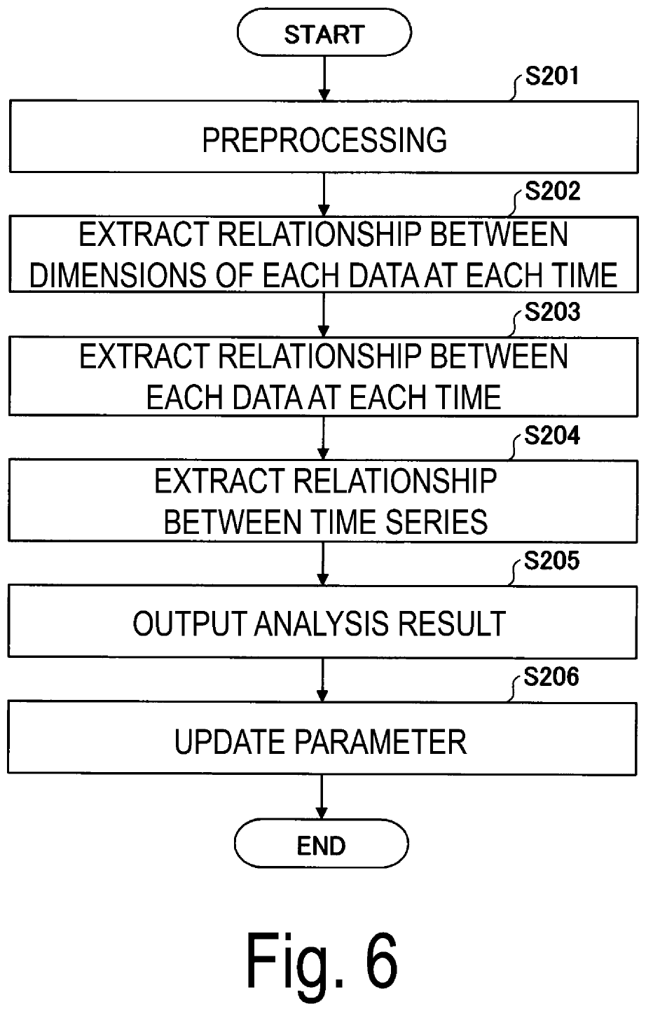

A parameter updating process in the learning state is described below with reference to FIG. 6. FIG. 6 is a flowchart illustrating an example of a parameter updating process according to the embodiment of the present invention. Note that it is assumed that in the data analysis process, the parameter of the CNN that implements each of the first relationship extraction unit 102, the second relationship extraction unit 103 and the third relationship extraction unit 104 has not yet been learned.

The step S201 to step S205 in FIG. 6 are the same as the step S101 to step S105 in FIG. 4, and therefore the description thereof will be omitted. It should be noted that time-series data included in learning data is used as time-series data to be subjected to data analysis.

After the step S205, the parameter updating unit 107 updates the parameter of the CNN that implements each of the first relationship extraction unit 102, the second relationship extraction unit 103 and the third relationship extraction unit 104 through the use of the data analysis result output at step S205 and teacher data included in the learning data (step S206). Specifically, the parameter updating unit 107 updates the parameter of the CNN by a known optimization method so as to reduce errors between the data analysis result and the teacher data. As the optimization method, stochastic gradient descent may be used, for example. In this manner, the parameter of the CNN for implementing the data analysis process is learned.

Note that the number of the CNN layers, the presence/absence of drop out and the like may be arbitrarily set. In addition, for example, in the case where the first relationship extraction unit 102 is implemented using an encoder of an autoencoder, the parameter to be updated is the parameter of the encoder.

The present invention is not limited to the embodiments specifically disclosed above, and various modification and alterations may be made without departing from the scope of the claims.

### REFERENCE SIGNS LIST

10 Data analysis system
101 Preprocessing unit
102 First relationship extraction unit
103 Second relationship extraction unit
104 Third relationship extraction unit
105 Output unit
106 User interface unit
107 Parameter updating unit
110 Storage unit

1. A data analysis system comprising:
a first feature amount extraction unit, including one or more processors, configured to extract, from time-series data of a plurality of types, a first feature amount representing a feature between dimensions of each data of the time-series data at each time;
a second feature amount extraction unit, including one or more processors, configured to extract, from the first feature amount extracted by the first feature amount extraction unit, a second feature amount representing a feature between the types at each time;
a third feature amount extraction unit, including one or more processors, configured to extract, from the second feature amount extracted by the second feature amount extraction unit, a third feature amount representing a feature between each time; and
an analysis unit, including one or more processors, configured to perform predetermined data analysis through a use of the third feature amount extracted by the third feature amount extraction unit.

2. The data analysis system according to claim 1,
wherein the first feature amount extraction unit is configured to extract the first feature amount through a use of a first convolutional neural network using a first learned parameter learned in advance, a principal component analysis, or an encoder of an autoencoder using a learned parameter learned in advance;
wherein the second feature amount extraction unit is configured to extract the second feature amount through a use of a second convolutional neural network using a second learned parameter learned in advance; and
wherein the third feature amount extraction unit is configured to extract the third feature amount through a use of a third convolutional neural network using a third learned parameter learned in advance.

3. The data analysis system according to claim 1, wherein the analysis unit is configured to output a data analysis result from the third feature amount through a use of a function that is prepared for each type of the types in accordance with a purpose of the data analysis.

4. A data analysis method of causing a computer to execute:
a first feature amount extraction procedure of extracting, from time-series data of a plurality of types, a first feature amount representing a feature between dimensions of each data of the time-series data at each time;
a second feature amount extraction procedure of extracting, from the first feature amount extracted by the first feature amount extraction procedure, a second feature amount representing a feature between the types at each time;
a third feature amount extraction procedure of extracting, from the second feature amount extracted by the second feature amount extraction procedure, a third feature amount representing a feature between each time; and
an analysis procedure of performing predetermined data analysis through a use of the third feature amount extracted by the third feature amount extraction procedure.

5. A non-transitory computer readable medium storing a program for causing a computer to execute:
a first feature amount extraction procedure of extracting, from time-series data of a plurality of types, a first feature amount representing a feature between dimensions of each data of the time-series data at each time;
a second feature amount extraction procedure of extracting, from the first feature amount extracted by the first feature amount extraction procedure, a second feature amount representing a feature between the types at each time;
a third feature amount extraction procedure of extracting, from the second feature amount extracted by the second feature amount extraction procedure, a third feature amount representing a feature between each time; and
an analysis procedure of performing predetermined data analysis through a use of the third feature amount extracted by the third feature amount extraction procedure.

6. The data analysis method according to claim 4, further comprising:
extracting the first feature amount through a use of a first convolutional neural network using a first learned parameter learned in advance, a principal component analysis, or an encoder of an autoencoder using a learned parameter learned in advance;
extracting the second feature amount through a use of a second convolutional neural network using a second learned parameter learned in advance; and
extracting the third feature amount through a use of a third convolutional neural network using a third learned parameter learned in advance.

7. The data analysis method according to claim 4, further comprising:
outputting a data analysis result from the third feature amount through a use of a function that is prepared for each type of the types in accordance with a purpose of the data analysis.

8. The non-transitory computer readable medium according to claim 5, wherein the program further causes the computer to execute:
extracting the first feature amount through a use of a first convolutional neural network using a first learned parameter learned in advance, a principal component analysis, or an encoder of an autoencoder using a learned parameter learned in advance;
extracting the second feature amount through a use of a second convolutional neural network using a second learned parameter learned in advance; and
extracting the third feature amount through a use of a third convolutional neural network using a third learned parameter learned in advance.

9. The non-transitory computer readable medium according to claim 5, wherein the program further causes the computer to execute:
outputting a data analysis result from the third feature amount through a use of a function that is prepared for each type of the types in accordance with a purpose of the data analysis.
